(19) United States
(12) Patent Application Publication
(10) Pub. No.: US 2026/0007116 A1
(43) Pub. Date: Jan. 8, 2026

(54) SUPPORT FOR AN AUTOMATED LITTER DEVICE

(71) Applicant: Automated Pet Care Products, LLC D/B/A Whisker, Auburn Hills, MI (US)

(72) Inventor: Troy Bell, White Lake, MI (US)

(21) Appl. No.: 19/256,783

(22) Filed: Jul. 1, 2025

Related U.S. Application Data
(60) Provisional application No. 63/667,478, filed on Jul. 3, 2024.

(51) Int. Cl. A01K 1/01

(52) U.S. Cl. CPC A01K 1/0114

(57) ABSTRACT

A support for a litter device having: a) an interface portion configured to engage with the litter device and including one or more engagement features for engaging with a bottom of a base of the litter device; and b) a base portion adjacent to the interface portion configured to extend away from the litter device and provide distribution of a weight of the litter device; and wherein the support is configured to be located at least partially between the base and a support surface the litter device rests upon and the support is configured to prevent tipping over of the litter device.

### CROSS REFERENCE TO RELATED APPLICATIONS

This application claims priority from U.S. Provisional Application No. 63/667,478, filed on July 3, 2024, and which is incorporated herein by reference in its entirety for all purposes.

### FIELD

The present teachings relate to a support for litter devices. The support may be beneficial in supporting unbalanced weight of a litter device. The support may allow for integration of accessories to a litter device and allowing for distribution of the additional weight.

### BACKGROUND

Automated litter devices may provide a means for pet owners (e.g., user) to effectively manage waste eliminated by one or more of their pets. These automated litter devices may be advantageous in automatically removing waste contents from litter; automatically collecting waste for subsequent disposal; storing waste contents separate from a litter chamber such that they are not exposed to the ambient environment, thereby preventing and/or reducing smell from the waste. Examples of some automated litter boxes which may be particularly beneficial may be found in US Patent Nos. 6,463,881; 8,757,094; 9,433,185; and 11,925,169 which are incorporated herein by reference in their entirety for all purposes. A challenge associated with automated litter devices is the dependence on a human for refilling with clean litter. Elegant examples of a litter dispenser which allows for increased litter capacity and automatic refilling are disclosed in US Patent No. 11,925,169 and PCT Publication No. WO 2020/219849, which are incorporated herein by reference in their entirety for all purposes. The addition of a litter dispenser or other accessories to a litter device can lead to an unbalanced shift in weight causing the litter device to tip over. Thus, what is needed is a simple means of supporting and balancing the litter device when the additional weight of an accessory, such as a litter dispenser, is added.

### SUMMARY

The present teachings relate to a support for a litter device comprising: a) an interface portion configured to engage with the litter device; and b) a base portion configured to provide distribute the weight of the litter device.

The present teachings relate to a support for a litter device comprising: a) an interface portion configured to engage with the litter device and including one or more engagement features for engaging with a bottom of a base of the litter device; and b) a base portion adjacent to the interface portion configured to extend away from the litter device and provide distribution of a weight of the litter device; and wherein the support is configured to be located at least partially between the base and a support surface the litter device rests upon and the support is configured to prevent tipping over of the litter device.

The present teachings relate to a support for a litter device comprising: a) an interface portion configured to engage with the litter device, wherein the interface portion includes: i) a bottom flange; ii) one or more engagement features extending from the bottom flange and configured to engage with the litter device; iii) one or more reciprocal walls configured to have a portion of the litter device resting thereon; and b) a base portion configured to provide distribute the weight of the litter device, wherein the base portion extends from the one or more reciprocal walls opposite the bottom flange.

The present teachings relate to an assembly comprising: a) a litter device including: a base; a chamber configured for retaining a litter, and configured for allowing an animal to enter and exit to eliminate a waste; wherein the chamber is rotatably supported on a base; and wherein the litter device is an automated litter device; b) a litter dispenser affixed to a rear of the litter device and in fluid communication with the chamber; wherein the litter dispenser is configured to automatically dispense a portion of the litter into the chamber; and c) a support at a rear of the litter device and affixed to a bottom of the base; wherein the support projects away from the base and is located underneath the litter dispenser; wherein the support is configured to prevent tipping over of the litter device due to a weight of the litter dispenser; and wherein the support includes: i) an interface portion engaged with the base of the litter device, wherein the interface portion is located between a support surface on which the litter device rests and a bottom of the base of the litter device; wherein the interface portion includes one or more engagement features which are engaged with the bottom of the base of the litter device such as to affix the support to the base; and ii) a base portion configured to provide distribution of a weight of the litter device, wherein the base portion extends away from the base of the litter device; and wherein the base portion is integrally formed with the interface portion.

The support of the present teachings may be permanently and/or removably affixed to the litter device. The support may be affixed to the base of the litter device. The support may be affixed on a same side of the litter device as a litter dispenser.

The support of the present teachings may be advantageous in addressing a change in center of gravity of a litter device when one or more accessories are affixed to the litter device. The support may be beneficial in preventing tipping over. The support may be configured to maintain the litter device balanced when a litter dispenser is also affixed to and/or part of the litter device.

### BRIEF DESCRIPTION OF DRAWINGS

FIG. 1 is a cross-section view of an assembly of a litter device, litter dispenser, and support.

FIG. 2 is a front perspective view of a support.

FIG. 3 is a rear perspective view of a support.

FIG. 4 is a front view of a support.

FIG. 5 is a rear view of a support.

FIG. 6 is a left side view of a support.

FIG. 7 is a right side view of a support.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Support

The present teachings relate to a support. A support may function to prevent a litter device from tipping over, distribute weight of a litter device, allow for accessories to be added to a litter device, or a combination thereof. A support may function similar to a kickstand. A support may be integral or affixed to a housing of a litter device. A support may be permanently or removably affixed to a housing of a litter device. A support may be removably affixed to a base of a litter device. A support may be located anywhere such as to distribute the weight of the litter device and prevent tipping. A support may be located and/or biased toward a same side of the litter device as one or more accessories. A support may be located underneath one or more accessories. A support may be located on a same side of a litter device as a litter dispenser. A support may be located underneath a litter dispenser. A support may be located at a rear of the litter device. The support may have an interface portion and a base portion.

The support may include an interface portion. An interface portion may function as an interface between the support and the litter device. The interface portion may function to affix the support to the litter device. The interface portion may function to provide a resting surface for at least a portion of the litter device to rest on. The interface portion may include one or more portions substantially reciprocal with one or more portions of the litter device. The interface portion may include one or more features which are received by and/or receive one or more features of the litter device. The interface portion may function as an interface with a base of a litter device. A base of a litter device may rest on and/or engage with the interface portion. The interface portion may include a bottom flange, one or more engagement features, a reciprocal wall, the like, or a combination thereof.

The interface portion may include a bottom flange. A bottom flange may function to allow a portion of a litter device to rest thereon, to support one or more engagement features, to support one or more reciprocal walls, the like, or a combination thereof. The bottom flange may define a front most surface of the support. The bottom flange may have a cross-sectional shape (i.e., from top view) similar to a portion of a cross-sectional shape of a base. The cross-sectional shape may be rectangular, arcuate, or both. The bottom flange may have a thickness which minimally impacts a resting angle of a base of a litter device. The bottom flange may have a thickness of about 0.05 inches or greater, 0.07 inches or greater, or even 0.09 inches or greater. The bottom flange may have a thickness of about 0.25 inches or less, about 0.2 inches or less, about 0.15 inches or less, or even about 0.1 inches or less. Projecting away from the bottom flange may be one or more engagement features. A frontmost face and/or edge of the flange may define the frontmost surface of the support portion.

The interface portion may include one or more engagement features. One or more engagement features may function to secure the support to a litter device, prevent movement of the support relative to the litter device, or both. The one or more engagement features may engage with any suitable portion of a litter device. The one or more engagement features may engage with a housing of a litter device. The one or more engagement features may engage with a base of a litter device. The one or more engagement features may include one or more features which are received within a litter device, receive a portion of a litter device, or both. The one or more engagement features may be one or more protrusions, depressions, openings, separate fasteners, the like, or any combination thereof. The one or more engagement features may be integrally formed as part of the support, affixed thereto, pass through one or more openings thereof, the like, or any combination thereof. The one or more engagement features may project from a bottom flange, toward a litter device, or both. The one or more engagement features may include one or more retention clips, hub inserts, or both.

One or more engagement features may include one or more retention clips. One or more retention clips may include one or more fasteners suitable for permanently and/or removably affixing the support to the litter device. The one or more retention clips may be configured to cooperate with one or more fastener openings of a litter device. The fastener openings may be formed in a bottom of a base of the litter device. The one or more retention clips may provide for simple and fast installation and require no additional tools for installation. The one or more retention clips may be compatible with a thickness of a bottom of a base of a litter device. The one or more retention clips may be any type of fastener or fastener body. The one or more retention clips may be similar to one or more fir tree fasteners, arrowhead fasteners, push pin fasteners, clip fasteners, hook-like fasteners, friction-fit fasteners, the like, or any combination thereof. The one or more retention clips may include one or more retention tabs. A retention tab may project from a main body of the retention clip. A retention tab may form a gap with the bottom flange. The gap may receive the bottom of the base therein. The retention tab may be rigid and/or flexible. The retention clips may be inserted into engagement openings of the base and engage simultaneously or be inserted and then slide into engagement. There may be 1 or more, 2 or more, 3 or more, or even 4 or more retention clips. There may be 10 or less, 8 or less, or even 6 or less retention clips. A pair of retention clips may flank a hub insert. A pair of retention clips may be biased toward opposing sides and/or corners of a bottom flange.

One or more engagement features may include one or more hub inserts. One or more hub inserts may function to allow one or more components of the litter device to pass therethrough. The one or more hub inserts may allow for one or more electrical components to pass through. One or more electrical components may include a power cable. The one or more hub inserts may project from a bottom flange, in a same direction as one or more retention clips, or both. The one or more hub inserts may be located between a front of the bottom flange and a reciprocal wall. The one or more hub inserts may be formed into the reciprocal wall. The one or more hub inserts may be received in one or more indentations and/or openings of the litter device. The one or more hub inserts may be received in one or more indentations of a housing (e.g., base) of a litter device. The hub insert may have a shape substantially reciprocal with a shape of the indentation of the housing of the litter device. The hub insert may have a substantially hollow interior. A power cable of a litter device may pass through the pass-through of the hub insert. A hub insert may align and be inserted within a reciprocal cavity of a housing, precent movement in one or more directions, but may not act as a fastener. In other words, a hub insert may be in a nesting engagement with the housing as opposed to fastener engagement. An upper surface and/or edge of the hub insert may or may not define an upper most surface of the support.

The interface portion may include a reciprocal wall. The reciprocal wall may function to apply a counter force to a litter device to prevent tipping. The reciprocal wall may extend away from a bottom flange. The reciprocal wall may be integral with and/or attached to one or more other portions of the support. The reciprocal wall may be configured to have a portion of a litter device resting thereon. The reciprocal wall may have a shape reciprocal with the portion of the litter device resting thereon. The reciprocal wall may have a shape reciprocal with one or more contours of the base of the litter device. The reciprocal wall may have a shape which is concave, planar, or both. The concavity may formed on a surface facing forward, toward the litter device, toward a base of the litter device, or a combination thereof. The front surface of the reciprocal wall may be sloped or a tangent line relative to the surface may be sloped. A slope may be at an angle relative to a bottom surface and/or support surface. A slope may be at a same, similar, or different angle than a slope of a base portion. A slope may face toward a rear of the support, away from one or more engagement features, or both. A slope may be measured along any length of the reciprocal wall. A slope may be measured at a mid-point of a height of the reciprocal wall. A slope may be at an angle of about 30 degrees or greater, about 40 degrees or greater, about 45 degrees or greater, about 50 degrees or greater, or even about 55 degrees or greater. A slope may be at an angle of about 90 degrees or less, about 80 degrees or less, about 70 degrees or less, about 65 degrees or less or even about 60 degrees or less. For example, a slope may be at an angle of about 40 degrees to about 80 degrees. For example, a slope may be at an angle of about 50 degrees to about 70 degrees. A reciprocal wall may have a front plan view or cross-sectional shape which is substantially at least partially circular, squared, rectangular, triangular, prismed, the like, or a combination thereof. For example, the reciprocal wall may have a front plan view or front cross-sectional shape which is substantially crescent-shaped. The reciprocal wall may separate the interface portion from the base portion. The base portion may extend from the reciprocal wall. An upper edge and/or surface of the reciprocal wall may or may not define an uppermost surface of the support. The reciprocal wall may have a height which is taller, shorter, or about equal to a height of one or more engagement features. A reciprocal wall may have a height taller than one or more retention clips. A reciprocal wall may have a height which is taller, shorter, or about equal to one or more hub inserts.

The support may include a base portion. The base portion may function to prevent tipping by provide support for a changed center of gravity when one or more accessories are added to a litter device. The base portion may function to extend support of a litter device further outward. The base portion may extend from the interface portion. The base portion may extend from a rear of a reciprocal wall. The base portion may be integral with or attached to interface portion, reciprocal wall, one or more other portions of the support, or any combination thereof. The base portion may taper away from the reciprocal wall. The base portion may slope down from the reciprocal wall toward the rearmost surface of the support. The slope may allow the base portion to provide support to the reciprocal wall. The slope may be at an angle relative to a bottom surface and/or support surface. The slope may be at an angle of about 5 degrees or greater, about 10 degrees or greater, about 15 degrees or greater, or even about 20 degrees or greater. The slope may be at an angle of about 50 degrees or less, about 40 degrees or less, about 35 degrees or less, or even about 30 degrees or less. For example, the slope may be at an angle of about 20 degrees to about 30 degrees. The angle may face toward the reciprocal wall, a front of the support, or both. The base portion may be solid or have one or more voids. The base portion may be loop-shaped. For example, the base portion may include opposing arms which form at least a portion of the sides of the support and slope away from the reciprocal wall. The opposing arms may then be connected together via a connection arm. The base portion may extend away from a base of a litter device. The base portion may extend away from the litter device in a same direction as a litter dispenser. An outer edge and/or surface of the base portion may define a rearmost surface of the support.

The support may have a depth. A depth should be sufficient to distribute the weight and prevent tipping. A depth may be measured from the frontmost surface to the rearmost surface. A depth may be measured from the front of a bottom flange to the rear of a base portion. The depth may be about 2 inches or greater, about 2.5 inches or greater about, 3 inches or greater, or even about 3.5 inches or greater. The depth may be about 12 inches or less, 10 inches or less, 8 inches or less, or even 5 inches or less. A depth may be as minimal as possible so that the overall footprint of the litter device is minimally impacted. A depth may also be referred to as a length. A length of the support may be sufficiently small as to either minimally or not at all impact the overall length (e.g., depth) of a litter device. The support may have a length such that it may not extend further than a litter dispenser. The support may have a length relative to a length of a base of the litter device. The support may have a length which is about 5% or greater, about 10% or greater, about 15% or greater, or even about 20% or greater relative to a length of a base of the litter device. The support may have a length which is about 50% or less, about 40% or less, about 35% or less, or even about 30% or less relative to a length of a base of the litter device. For example, a support may have a length which is about 15% to about 35% relative to a length of a base. For example, a support may have a length which is about 20% to about 30% relative to a length of a base.

The support may have a width. A width may be measured from side to side. The width may be about 2 inches or greater, about 3 inches or greater, about 3.5 inches or greater, or even about 4 inches or greater. The width may be about 12 inches or less, about 10 inches or less, or even about 8 inches or less. The width of the support may be sufficiently small such as to minimally impact the overall width of the litter device. The width of the support may be smaller than a width of the litter device. The width of the support may be smaller than a width of the base of the litter device.

The support may have a height. A height should be sufficient to provide support and counterforce to a litter device. The height may be measured from the bottom to the topmost (e.g., uppermost) surface. The height may be the distance from the bottom to the top of the reciprocal wall and/or hub insert. A height may not impact interior components of a litter device. A height may be smaller than a width and/or depth of the support. A height may be sufficient as to avoid interfering with rotation of a chamber, insertion of a litter dispenser, or both. A height may be sufficiently small such that an uppermost surface of the support is located under a dispenser, under a bonnet, under a rotational axis of a chamber, the like, or a combination thereof. The height may be about 0.5 inches or greater, about 1 inch or greater, or even about 1.5 inches or greater. The height may be about 10 inches or less, about 8 inches or less, about 6 inches or less, or even about 4 inches or less. The support may have a height relative to a height of the litter device. The support may have a height which is about 2% or greater, about 4% or greater, or even about 5% or greater relative to an overall height of a litter device. The support may have a height which is about 30% or less, about 20% or less, about 15% or less, or even about 10% or less relative to an overall height of a litter device. For example, a support may have a height which is about 2% to about 15% relative to an overall height of a litter device. The support may have a height which is about 5% or greater, about 8% or greater, about 10% or greater, about 12% or greater, or even about 15% or greater relative to a height of a base of the litter device. The support may have a height which is about 50% or less, about 40% or less, about 30% or less, about 25% or less, or even about 20% or less relative to a height of a base of the litter device. For example, the support may have a height which is about 5% to about 25% relative to a height of a base of the litter device.

### Litter Device

The present teachings may relate to a litter device. The teachings may be particularly relevant to a litter device which is an automated litter device. An automated litter device may be any type of litter device which automates cleaning of the device after elimination of waste by an animal. A litter device may include one in which a chamber rotates to cause rotation of a sifting portion such that the sifting portion passes through litter and segregates waste from the litter. A litter device may include one in which a sifting portion rotates within a chamber to pass through the litter and segregate waste from the litter. A litter device may include an automated sifting scoop which moves axially and passes through litter retained within a stationary litter box to sift and segregate waste from litter.

The litter device may be configured to cooperate with a litter dispenser. The litter device may include a housing which supports the litter dispenser. The housing may include a dispenser pocket. The dispenser pocket may be reciprocal with one or more walls or other portions of the litter dispenser. The litter device may receive one or more portions of a litter dispenser therein. The litter device may electrically connect to the litter dispenser. A controller of the litter device may control one or more operations of the litter dispenser. The housing may include one or more openings. The one or more openings may be in fluid communication with the litter dispenser. The one or more openings may include a rear opening, waste opening, entry opening, any other suitable opening, the like, or any combination thereof. A chamber of the litter device may include a rear opening. The rear opening may receive the clean and unused litter from the litter dispenser therein. The rear opening may be opposite the entry opening, aligned with the rotational axis of the chamber, or both.

The litter device may include a bezel, a chamber, a box, a septum, a sifting scoop, a bonnet, a base, a waste receptacle, a track, a hub, an entry barrier, the like, or any combination thereof. The litter device may include a housing. The housing may refer to the outside portions of the litter device which house one or more interior components, such as the chamber. The chamber may include an entry opening. The chamber may be configured to hold litter. The chamber may be configured to allow an animal to enter and/or exit. The chamber may be configured to allow an animal to excrete waste within the interior. The chamber may include a septum. The septum may include a sifting portion. The sifting portion may be configured for sifting through litter and separating waste from litter. The litter device may include a waste receptacle. A waste receptacle may be in communication with the chamber. A waste receptacle may be configured to receive waste. A waste receptacle may receive waste from the chamber. The waste receptacle may be referred to as a waste bin. A waste receptacle may be configured as a waste drawer.

The present teachings may be useful for use with an automated litter device having a chamber supported by a base, having a waste drawer, or both. The teachings may also be useful for an automated litter device having an entry barrier which is able to block and allow access into a chamber. The chamber may be a portion of the device configured to hold litter, where an animal may enter and excrete waste, or both. The chamber may be supported by and/or rest above a base. The chamber may be rotatably supported by the base. The chamber may rotate through one or more cleaning cycles to allow for funneling and disposal of waste. The chamber may have an axis of rotation. The axis of rotation may extend through the entry opening of the chamber. The axis of rotation may be concentric or off-center with the entry opening. The axis of rotation may be a tilted axis of rotation. The tilted axis of rotation may promote funneling and disposal of waste, increased line of sight of one or more sensors, or both. The chamber may include a septum such that rotation of the chamber may result in rotation of a septum which sifts through the litter. The septum may filter clean litter from clumps of waste and guide funneling and/or disposal of the waste. Waste from the chamber may be disposed into a waste drawer. A waste drawer may be located in a support base of the device, below a chamber, adjacent to a chamber, or any combination thereof. A litter dispenser may be affixed to the litter device to replenish litter disposed during cleaning cycles. A bonnet may be located at least partially over a chamber to cover one or more components of the litter device, prevent access to one or more pinch points, or both. The overall litter device, chamber, bezel, cleaning cycle of the chamber, rotational capability, axis of rotation (e.g., tilted rotational axis) base (e.g., support base), bonnet, waste drawer, litter dispenser, and other components of the litter device may be configured such as those disclosed in US Patent Nos. 8,757,094; and 9,433,185; US Publication No: 2019/0364840; and PCT Patent Application No.: PCT/US2020/029776 (Published as PCT Publication No. WO 2020/219849A1), which are incorporated herein by reference in their entirety for all purposes.

### Litter Dispenser

The present teachings further relate to a litter dispenser. A litter dispenser may function to store clean and unused litter; refill a litter device, a chamber, or both with clean and unused litter; extend the usability of a litter device without human intervention; or any combination thereof. The litter dispenser may be particularly useful in extending the usability of a litter device without human intervention. For example, a waste drawer may have a waste storage capacity greater than the litter capacity in the chamber. Capacity may be measured in volume, usage frequency by an animal, or even days. During a cleaning cycle, used litter is transferred into the waste drawer along with animal waste, such that over time the usable litter may be depleted. The usable litter in the chamber may be depleted before the waste drawer is full. Traditionally, a human would have to intervene and refill the chamber with fresh litter for continued use of the litter device by an animal. The litter dispenser may be particularly advantageous in reducing human intervention with the litter device. The litter dispenser may automatically deliver clean, unused litter into the chamber. The litter dispenser may deliver litter into the chamber once the litter within the chamber reaches a certain quantity (e.g., volume, height, etc.), after a certain waste type has been detected and removed from the chamber, or both. The level of litter within the chamber may be sensed by one or more sensors. For example, one or more presence sensors, waste sensors, mass sensors, or a combination thereof may sense the quantity of litter within the chamber. The litter stored within the litter dispenser may be any kind of litter suitable for use with the litter device.

The litter dispenser may have any size, shape, and/or configuration to be in fluid communication with a litter device. The litter dispenser may be in fluid communication with an interior of a chamber, cooperate with a rotating chamber and/or septum, or both. The litter dispenser may be affixed to a litter device; part of a litter device; affixed to a housing of a litter device; affixed to a base, bonnet, chamber, or any combination thereof. The litter device may have the ability to transfer a portion of litter stored therein into a chamber, have the ability to store litter, or both. The litter dispenser may be located generally opposite an entry opening, adjacent an entry opening, in between an entry opening and an opposing surface, near a base, adjacent to a waste opening, aligned with a waste opening, the like, or any combination thereof of a litter device. The litter dispenser may be located at a rear of a litter device, generally opposite of the entry opening. The litter dispenser may be located toward a top of a litter device, generally opposite of the base. The litter dispenser may be located near and/or part of a base. By being opposite the entry opening, above the entry opening, above a housing, at a rear, on the ground, or a combination thereof, the litter dispenser may not interfere with entry and exit by an animal, functionality with a septum and/or liner, or a combination thereof. The litter dispenser may be configured to dispense clean and unused litter through any suitable opening of the litter device such as to replenish litter. The litter dispenser may be configured to dispense clean and unused litter through an opening at the rear, the entry opening, the waste opening, any designated opening, the like, or a combination thereof.

A litter dispenser may include a hopper, dispenser housing, dispensing device, chute, the like, or a combination thereof. A hopper may function to store clean and unused litter. A dispenser housing may function to house a dispensing device. A dispensing device may function to transfer litter from the hopper to the litter device, chute, or both. A chute may function to transfer litter from a dispenser housing, dispensing device, or both into a chamber of a litter device. A chute may function to cooperate with a rear opening of a litter device. A chute may be located at a rear of a litter device. A chute may be at least partially aligned with a rotational axis of a chamber.

An exemplary litter dispenser may include a litter dispenser as disclosed in PCT Patent Application No.: PCT/US2020/029776 (Published as PCT Publication No. WO 2020/219849A1), which is incorporated herein by reference in its entirety for all purposes.

### Illustrative Examples

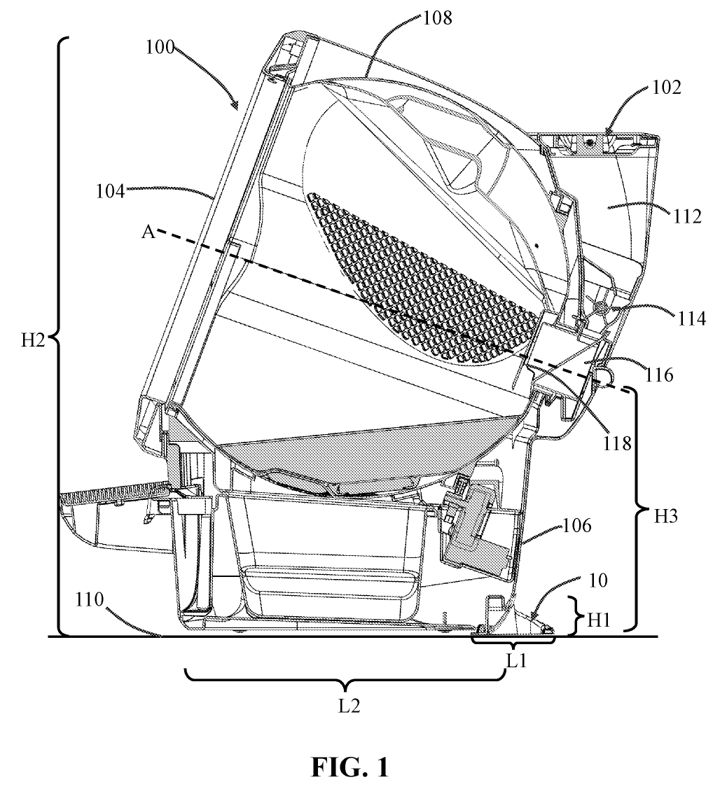

FIG. 1 illustrates a support 10 affixed to a litter device 100. The support 10 and litter device 100 both rest on a support surface 108 (e.g., ground, floor, table, platform). The litter device 100 includes a litter dispenser 102. The litter dispenser 102 is affixed at a rear of the litter device 100. The litter dispenser 102 is located opposite the entry opening 104. The litter device 100 includes a base 106. The base 106 supports a rotating chamber 108. The chamber 108 is configured to rotate about a rotational axis A. A portion of the litter dispenser 102 is at least partially aligned with the rotational axis A. The rotational axis A is tilted, such as to be offset from both a horizontal plane and vertical plane. The rotational axis A extends through the entry opening 104. The litter dispenser 102 includes a hopper 112, dispensing device 114, and chute 116. The chute 116 is at least partially aligned with a rear opening 118 of the chamber 108. The support 10 supports at least a portion of the base 106.

The support 10 is located at a rear of the base 106. The support 10 is located at least partially below the base 106. A portion of the support 10 is received within the base 106. A portion of the base 106 rests on the support 10. The support 10 is located on a same side of the litter device 100 as the litter dispenser 102. The support 10 is generally centered at a rear of the litter device 100.

The support 10 may include a length L1. The base 106 may include a length L2. A length may be measured from a frontmost surface of the support 10 and/or base 106 to the rearmost surface. The support may have a height H1. The litter device 100 may have a height H2. The base 106 may have a height H3. The height may be measured from a bottommost surface of the support 10 and/or litter device 100 to an uppermost surface.

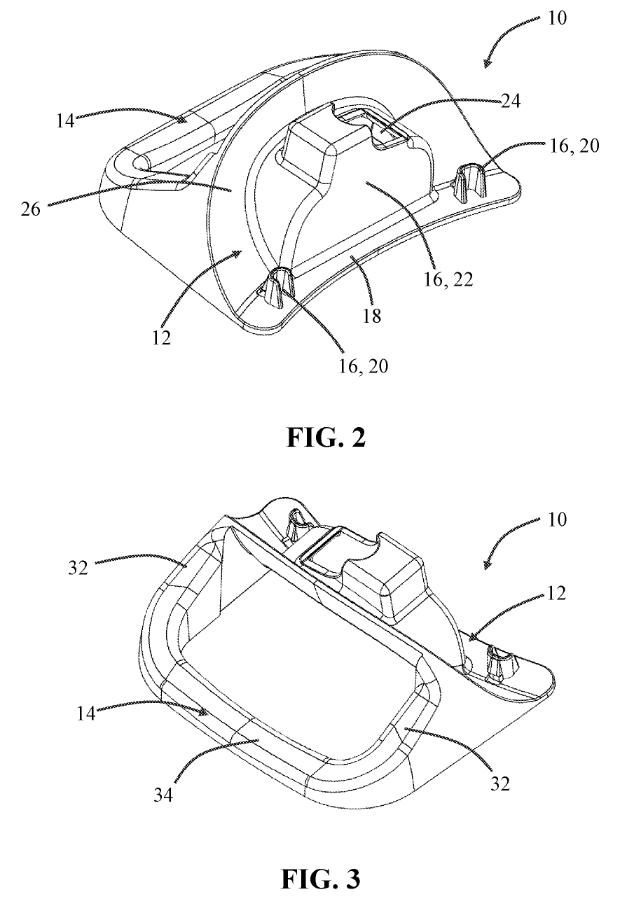

FIGS. 2 and 3 illustrate a support 10. The support 10 includes an interface portion 12. The interface portion 12 functions as the interface of the support 10 with the litter device 100 (not shown). The interface portion 12 may be at least partially underneath a base 106 (not shown) of the litter device 100 (not shown). Opposite the interface portion 12 is a base portion 14. The base portion 14 functions to distribute weight and support the litter device 100 (not shown).

The interface portion 12 includes one or more engagement features 16. The engagement features 16 are configured to be received within the litter device 100 (not shown). The engagement features 16 may be received within the base 106 (not shown). The engagement features 16 may extend from a bottom flange 18. The engagement features 16 include retention clips 20. The engagement features 16 include a hub insert 22. The hub insert 22 includes a pass-through 24.

The interface portion 12 includes a reciprocal wall 26. The reciprocal wall 26 is configured to be reciprocal with a surface of the base 106 (not shown). The reciprocal wall 26 has the base 106 rest thereon. The reciprocal wall 106 is configured to apply a counter-force to the base 106 such as to resist tipping of the litter device 100 (not shown). The reciprocal wall 26 has a concave curvature. The reciprocal wall 26 has a crescent shape.

Extending from the interface portion 12 is a base portion 14. The base portion 14 forms a closed- loop shape. While shown as hollow between the interface portion 12 and the base portion 14, it is also possible that this portion is solid. The base portion 14 may include opposing arms 32. The opposing arms may be connected together via a connection arm.

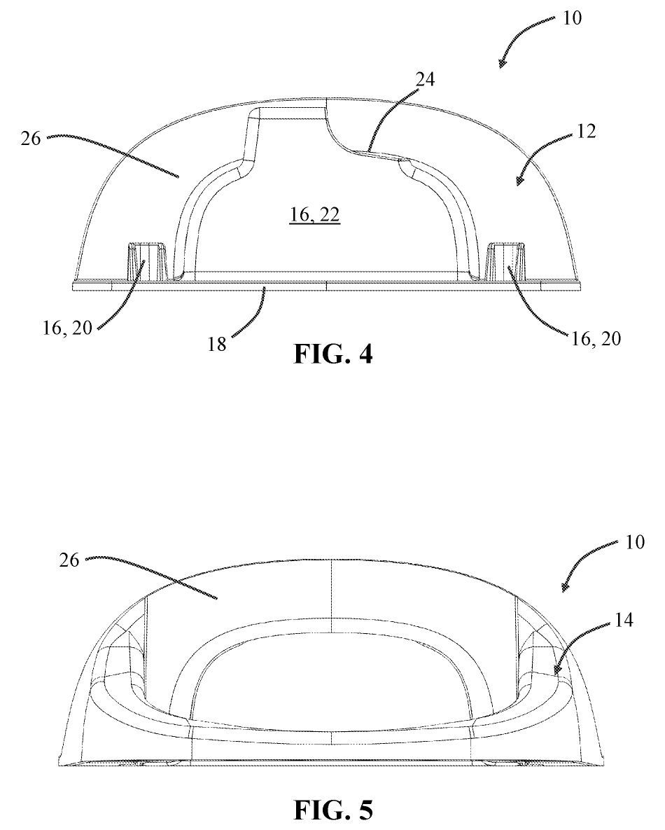

FIG. 4 illustrates a front view of the support 10. The support 10 includes an interface portion 12. The interface portion 12 includes a reciprocal wall 26. The crescent cross-sectional shape of the reciprocal wall 26 can be seen in the front view. The bottom flange 18 projects from the reciprocal wall 26. Extending from the bottom flange 18 are engagement features 16. The engagement features 16 include retention clips 20. The engagement features 16 include a hub insert 22. The hub insert 22 includes a pass-through 24.

FIG. 5illustrates a rear view of the support 10. The support 10 includes a base portion 14. The base portion 14 functions like a kickstand. The base portion 14 is integral with and projects from the reciprocal wall 26.

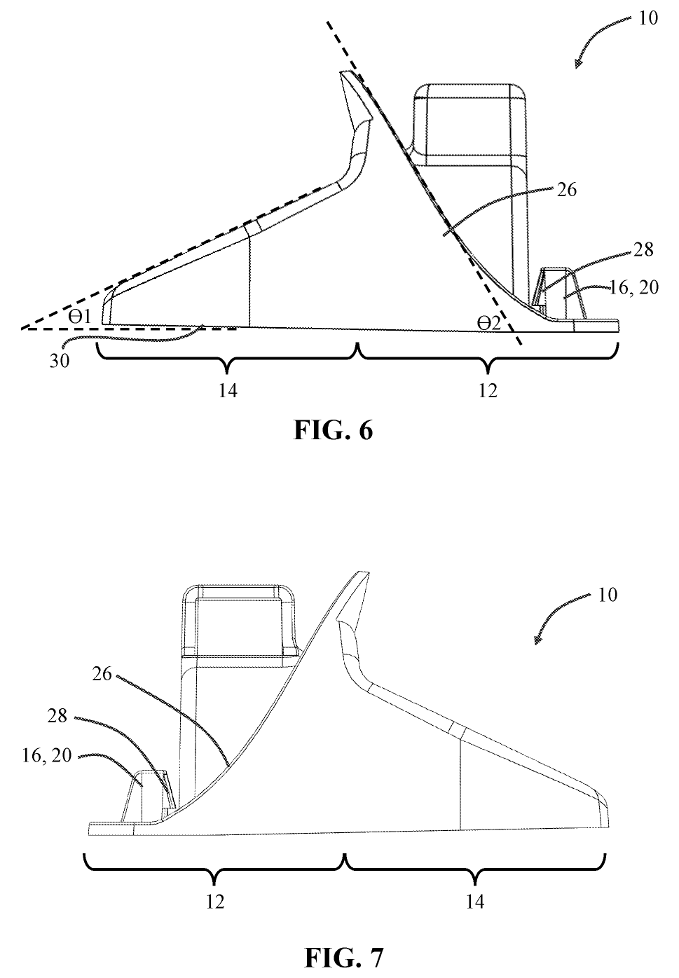

FIGS. 6 and 7 illustrate side views of the support 10. The support 10 includes an interface portion 12 having a base portion 14 extending therefrom. Viewable from the side profile is the concave curvature the reciprocal wall 26. Retention clip 20 includes a retention tab 28. An upper surface of the base portion 14 is sloped at an angle 81 relative to a bottom surface 30 of the support 10 and/or support surface 110 (not shown). A forward facing surface of the reciprocal wall 26 is concave. A line tangent to the forward facing surface of the reciprocal wall is sloped. The tangent line may be a line which touches the forward facing surface at or at about the mid-height of the reciprocal wall 26. The slope may be at an angle 82 relative to a bottom surface 30 of the support 10 and/or support surface 110 (not shown).

### Reference Numbers

10 -Support

12 - Interface portion

14- Base portion

16 - Engagement feature

18 - Bottom flange

20 - Retention clip

22 -Hub insert

24- Pass-through

26 – Reciprocal wall

28 – Retention tab

30 – Bottom surface

32 – Opposing arms

34 – Connection arm

100 – Litter device

102 – Litter dispenser

104 – Entry opening

106 – Base

108 – Chamber

110 – Support surface

112 – Hopper

114 – Dispensing device

116 – Chute

118 – Rear opening

A – rotational axis

H1 – Height of support

H2 – Height of litter device

H3 – Height of base

L1 – Length of support

L2 – Length of base of litter device

ϴ1 – Angle of base portion slope

ϴ2 – Angle of reciprocal wall slope

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms "generally", "substantially", and even "about" to describe angular measurements may mean about +/- 100 or less, about +/- 5° or less, or even about +/- 10 or less. The terms "generally", "substantially", and even "about" to describe angular measurements may mean about +/- 0.010 or greater, about +/- 0.10 or greater, or even about +/- 0.50 or greater. The terms "generally", "substantially", or even "about" to describe linear measurements, percentages, or ratios may mean about +/- 10% or less, about +/-5% or less, or even about +/- 1% or less. The terms "generally", "substantially", or even "about" to describe linear measurements, percentages, or ratios may mean about +/- 0.01% or greater, about +/- 0.1% or greater, or even about +/- 0.5% or greater.

The term "consisting essentially of' to describe a combination shall include the elements, ingredients, components, or steps identified, and such other elements ingredients, components or steps that do not materially affect the basic and novel characteristics of the combination. The use of the terms "comprising" or "including" to describe combinations of elements, ingredients, components, or steps herein also contemplates embodiments that consist essentially of the elements, ingredients, components, or steps. Plural elements, ingredients, components, or steps can be provided by a single integrated element, ingredient, component, or step. Alternatively, a single integrated element, ingredient, component, or step might be divided into separate plural elements, ingredients, components, or steps. The disclosure of "a" or "one" to describe an element, ingredient, component, or step is not intended to foreclose additional elements, ingredients, components, or steps.

What is claimed is:

1. A support for a litter device comprising:
a) an interface portion configured to engage with the litter device and including one or more engagement features for engaging with a bottom of a base of the litter device; and
b) a base portion adjacent to the interface portion configured to extend away from the litter device and provide distribution of a weight of the litter device; and
wherein the support is configured to be located at least partially between the base and a support surface the litter device rests upon and the support is configured to prevent tipping over of the litter device.

2. The support of claim 1, wherein the one or more engagement features includes one or more retention clips, one or more hub inserts, or both.

3. The support of claim 2, wherein the one or more engagement features include the one or more retention clips which are configured to engage with one or more fastener openings of the base of a litter device.

4. The support of claim 3, wherein the one or more retention clips are configured to be removable from the one or more fastener openings.

5. The support of claim 2, wherein the one or more engagement features include the one or more hub inserts, wherein the one or more hub inserts are configured to nest within one or more cavities formed in the base of the litter device, and wherein the one or more hub inserts include one or more pass- throughs formed therein.

6. The support of claim 2, wherein the support includes a bottom flange formed in the interface portion and wherein the one or more engagement features project upward from the bottom flange;
and wherein the one or more engagement features are located between a front surface of the bottom flange and a reciprocal wall of the interface portion.

7. The support of claim 1, wherein the interface portion includes a reciprocal wall which is configured to have a portion of the base of the litter device resting thereon;
wherein the base portion projects away from the reciprocal wall; and
wherein the reciprocal wall has a shape reciprocal the portion of the base which is to rest thereon.

8. The support of claim 7, wherein a front surface of the reciprocal wall is at least partially concave.

9. The support of claim 7, wherein a front surface of the reciprocal wall is either sloped or a line tangent to the front surface of the reciprocal wall is sloped; andwherein a slope of the front surface or the line is about 40 degrees to about 80 degrees.

10. The support of claim 9, wherein the slope is taken at a mid-height of the front of the reciprocal wall and wherein the slope is about 50 degrees to about 70 degrees.

11. The support of claim 9, wherein the reciprocal wall is located between the base portion and the one or more engagement features.

12. The support of claim 1, wherein the base portion includes an upper surface which slopes down toward a rearmost surface of the support; andwherein a slope of the upper surface is about 5 degrees to about 50 degrees.

13. The support of claim 12, wherein the slope is about 15 degrees to about 35 degrees.

14. The support of claim 12, wherein the base portion is solid or includes one or more voids.

15. The support of claim 14, wherein the base portion is formed by two opposing arms connected together by a connection arm.

16. The support of claim 15, wherein the two opposing arms include the upper surface of the base portion and are sloped downward toward the connection arm; andwherein the two opposing arms form two opposing sides of the support.

17. The support of claim 1, wherein the support is a one-piece component and the support is free of additional attachment mechanisms to be affixed to the litter device.

18. The support of claim 1, wherein the support is affixed to a base of the litter device;
wherein the support has a length which is about 15% to about 35% relative to a length of the base; and
wherein the support has a height which is about 2% to about 15% relative to an overall height of the litter device.

19. The support of claim 18, wherein the support is affixed on a rear of the litter device;
wherein the litter device includes a litter dispenser at the rear of the litter device and above the support; and
wherein the support provides additional stability to the litter device to avoid tipping over due to the weight of the litter dispenser.

20. An assembly comprising:
a) a litter device including: a base; a chamber configured for retaining a litter, and configured for allowing an animal to enter and exit to eliminate a waste; wherein the chamber is rotatably supported on a base; and wherein the litter device is an automated litter device;
b) a litter dispenser affixed to a rear of the litter device and in fluid communication with the chamber;wherein the litter dispenser is configured to automatically dispense a portion of the litter into the chamber; and
c) a support at a rear of the litter device and affixed to a bottom of the base; wherein the support projects away from the base and is located underneath the litter dispenser; wherein the support is configured to prevent tipping over of the litter device due to a weight of the litter dispenser; and
wherein the support includes:
i) an interface portion engaged with the base of the litter device, wherein the interface portion is located between a support surface on which the litter device rests and a bottom of the base of the litter device; wherein the interface portion includes one or more engagement features which are engaged with the bottom of the base of the litter device such as to affix the support to the base; and
ii) a base portion configured to provide distribution of a weight of the litter device, wherein the base portion extends away from the base of the litter device; and wherein the base portion is integrally formed with the interface portion.
